(19) United States
(12) Patent Application Publication
(10) Pub. No.: US 2023/0286505 A1
(43) Pub. Date: Sep. 14, 2023

(54) DRIVING ASSISTANCE APPARATUS

(71) Applicants: TOYOTA JIDOSHA KABUSHIKI KAISHA, Toyota-shi (JP); DENSO CORPORATION, Kariya-city (JP)

(72) Inventors: Hideki KAMATANI, Nagoya-shi (JP); Masayuki HOSOKAWA, Toyota-shi (JP); Yuuki TAKEUCHI, Tokyo-to (JP); Ryotarou ARAKI, Tokyo-to (JP); Yasuhiro IMAI, Tokyo-to (JP)

(73) Assignees: TOYOTA JIDOSHA KABUSHIKI KAISHA, Toyota-shi (JP); DENSO CORPORATION, Kariya-city (JP)

(21) Appl. No.: 18/178,891

(22) Filed: Mar. 6, 2023

(30) Foreign Application Priority Data
Mar. 14, 2022 (JP) 2022-39038

(51) Int. Cl. B60W 30/165; B60W 30/18

(52) U.S. Cl. CPC B60W 30/165; B60W 30/18163; B60W 2554/80

(57) ABSTRACT

A driving assistance apparatus includes an on-vehicle sensor and a driving assistance ECU. The ECU detects presence of a preceding vehicle traveling immediately forward of an own vehicle, on the basis of pieces of information from the sensor, chooses the preceding vehicle as a vehicle to follow, and controls a drive apparatus, a braking apparatus, and a steering apparatus such that the own vehicle follows the vehicle to follow. When the own vehicle follows a first vehicle chosen as the vehicle to follow and the speed of the own vehicle or the first vehicle is a predetermined threshold speed or lower, upon determination that the own vehicle can follow a second vehicle traveling faster than the own vehicle in a second lane located adjacent to a first lane in which the own vehicle is traveling, the ECU changes the vehicle to follow from the first vehicle to the second vehicle.

### BACKGROUND OF THE INVENTION

### Field of the Invention

The present invention relates to a driving assistance apparatus which controls a drive apparatus, a braking apparatus, etc. of an own vehicle such that the own vehicle follows a preceding vehicle.

### Description of the Related Art

Conventionally, there has been known a driving assistance apparatus (hereafter referred to as a “conventional apparatus”) which controls a drive apparatus, a braking apparatus, etc. of an own vehicle such that the own vehicle follows a preceding vehicle (a vehicle traveling immediately forward of the own vehicle) (see, for example, Japanese Patent Application Laid-Open (kokai) No. WO2011/158307). This conventional apparatus controls the drive apparatus and the braking apparatus such that the distance between the own vehicle and the preceding vehicle coincides with a predetermined difference.

Incidentally, in general, the fuel consumption rate (fuel efficiency) of a vehicle correlates with vehicle speed. For example, in a speed range of 80 km/h or lower, the higher the vehicle speed, the lower the fuel consumption rate, and, in a speed range higher than 80 km/h, the lower the vehicle speed, the lower the fuel consumption rate. Also, in the case where a preceding vehicle is present, the air resistance acting on the vehicle decreases and its fuel consumption rate becomes lower, as compared with the case where no preceding vehicle is present. However, in the case where the speed of the preceding vehicle is extremely low, a relatively long time is needed to arrive at a destination.

One object of the present invention is to provide a driving assistance apparatus which can reduce delay in time of arrival at a destination while limiting fuel consumption rate.

In order to solve the above-described problem, a driving assistance apparatus (1) according to the present invention comprises:
an on-vehicle sensor (20) which obtains a piece of information regarding the position of an own vehicle, a piece of information regarding objects located around the own vehicle and a piece of information regarding operation of an operation section of the own vehicle and which outputs the obtained pieces of information; and
a control apparatus (10) which detects presence of a preceding vehicle which is traveling immediately forward of the own vehicle, on the basis of the pieces of information obtained from the on-vehicle sensor, chooses the preceding vehicle as a vehicle to follow, and controls at least one of a drive apparatus (30), a braking apparatus (40), and a steering apparatus (60) of the own vehicle such that the own vehicle follows the vehicle to follow.

The control apparatus is configured such that, when the own vehicle follows a first vehicle (V0) chosen as the vehicle to follow and speed (vs) of the own vehicle or speed (v0) of the first vehicle is equal to or lower than a predetermined threshold speed, upon determination, on the basis of the pieces of information obtained from the on-vehicle sensor, that the own vehicle can follow a second vehicle (V1) which is traveling faster than the own vehicle in a second lane (Lb) located adjacent to a first lane (La) in which the own vehicle is traveling, the control apparatus changes the vehicle to follow from the first vehicle to the second vehicle.

In the driving assistance apparatus according to the present invention, in the case where the first vehicle is traveling at an extremely low speed in a state in which the own vehicle follows the first vehicle, the control apparatus can change the vehicle to follow, from the first vehicle to the second vehicle traveling in the adjacent lane. Thus, the own vehicle can overtake the first vehicle while following the second vehicle. At that time, since the own vehicle follows the second vehicle (travels immediately behind the second vehicle), the air resistance acting on the own vehicle at the time of overtaking is lower as compared with the case where the own vehicle travels solely. Therefore, fuel consumption can be limited. Also, as a result of overtaking of the first vehicle, it becomes possible for the own vehicle to travel faster than the first vehicle. Thus, it is possible to reduce delay in time of arrival at a destination, while limiting fuel consumption.

The control apparatus may be configured to change the vehicle to follow from the first vehicle to the second vehicle in the case where a difference (Δv) in speed between the own vehicle and the second vehicle in a state in which the own vehicle is traveling in the first lane is equal to or smaller than a predetermined threshold difference (Δvth).

If the second vehicle is traveling at an extremely high speed, it is difficult for the own vehicle to change its travel lane from the first lane to the second lane and follow the second vehicle. According to the present invention, it is possible to prevent choosing (employment) of the second vehicle traveling at high speed as a vehicle to follow.

The control apparatus may be configured such that, in the case where, after the own vehicle has overtaken the first vehicle while following the second vehicle, speed of the second vehicle traveling in the second lane exceeds the threshold speed and a region in which the own vehicle can travel is present in the first lane, the control apparatus controls the drive apparatus, the braking apparatus, and the steering apparatus such that the own vehicle moves from the second lane to the first lane.

By virtue of this configuration, in the case where the own vehicle becomes unable to follow the second vehicle after having overtaken the first vehicle, the own vehicle is caused to travel faster than the first vehicle in a region ahead of the first vehicle. Thus, it is possible to reduce delay in time of arrival at a destination, while limiting fuel consumption.

The control apparatus may be configured such that, when the control apparatus changes the vehicle to follow from the first vehicle to the second vehicle, the control apparatus detects not only a traveling state of the second vehicle but also a traveling state of a third vehicle (V2) traveling behind the second vehicle on the basis of the pieces of information obtained from the on-vehicle sensor, and determines whether or not the own vehicle can follow the second vehicle on the basis of the results of the detection.

This configuration can enhance safety at the time when the own vehicle overtakes the first vehicle, which was formerly chosen as a vehicle to follow (when the own vehicle changes its travel lane from the first lane to the second lane).

### BRIEF DESCRIPTION OF THE DRAWINGS

FIG. 1 is a block diagram of a driving assistance apparatus according to one embodiment of the present invention;

FIG. 2A is a plan view showing a state before an own vehicle overtakes a first vehicle;

FIG. 2B is a plan view showing a state in which a second vehicle has performed a lane change after the own vehicle had overtaken the first vehicle;

FIG. 2C is a plan view showing a state in which the own vehicle performs a lane change after the own vehicle has overtaken the first vehicle because the own vehicle cannot follow the second vehicle;

FIG. 3 is a flowchart of an ACC program;

FIG. 4 is a flowchart of an overtaking program; and

FIG. 5 is a flowchart of an overtaking program according to a modification of the present invention.

### DESCRIPTION OF THE PREFERRED EMBODIMENT

### Outline of Configuration

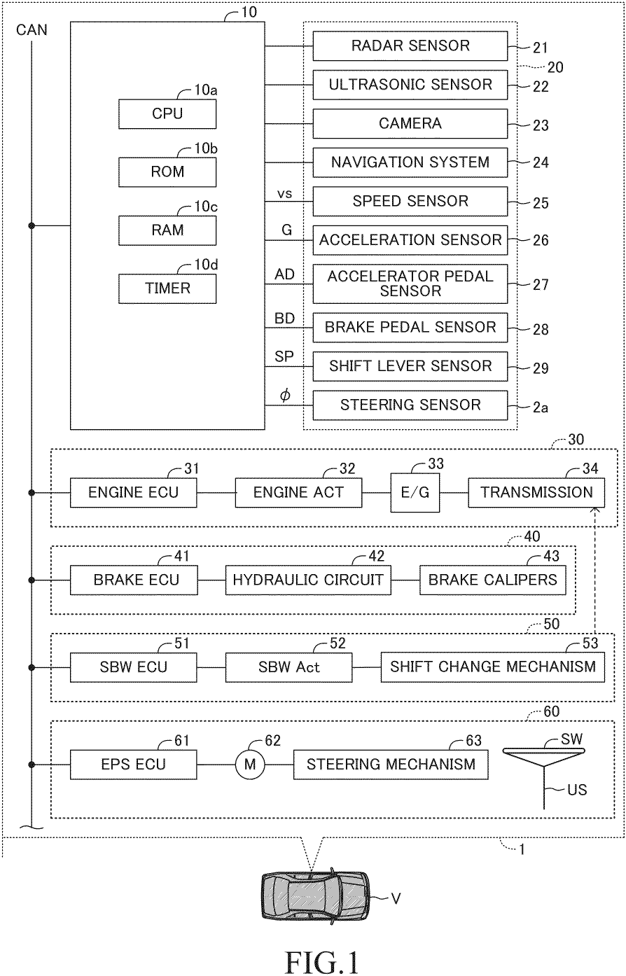

As shown in FIG. 1, a driving assistance apparatus 1 according to one embodiment of the present invention is mounted on a vehicle V. As will be described in detail later, the driving assistance apparatus 1 controls an engine, a brake, etc. of the vehicle V, on the basis of pieces of information obtained from sensors mounted on the vehicle V, such that the vehicle V travels at a constant speed or travels to follow another vehicle traveling immediately forward of the vehicle V. Herein, this control will be referred to as “cruise control.” In the following description, the vehicle V will be referred to as the “own vehicle.” Also, the vehicle traveling immediately forward of the vehicle V will be referred to as the “preceding vehicle.” Furthermore, another vehicle which is traveling in a lane adjacent to a lane (travel lane) in which the vehicle V is traveling will be referred to as the “adjacent vehicle.”

### Specific Configuration

As shown in FIG. 1, the driving assistance apparatus 1 includes a driving assistance ECU 10, on-vehicle sensors 20, a drive apparatus 30, a braking apparatus 40, a shift change apparatus 50, and a steering apparatus 60.

The driving assistance ECU 10 includes a microcomputer having a CPU 10a, a ROM 10b, a RAM 10c, a timer 10d, etc. Notably, in the present specification, “ECU” means an electronic control apparatus (electronic control unit) and includes a microcomputer having a CPU, a RAM, a ROM, etc. The CPU realizes various functions by executing instructions stored in the ROM.

The driving assistance ECU 10 is connected to other ECUs (an engine ECU 31, a brake ECU 41, an SBW ECU 51, and an EPS ECU 61, which will be described later) via a CAN (controller area network) such that pieces of information can be transmitted and received therebetween.

The on-vehicle sensors 20 include sensors for obtaining pieces of vehicle surrounding information, including information regarding three-dimensional objects present around the vehicle V and information regarding division lines on a road surface around the vehicle V. Namely, the on-vehicle sensors 20 include, for example, sensors for obtaining pieces of information regarding moving objects such as automobiles (other vehicles), pedestrians, and bicycles and stationary objects such as white lines on the road surface, guard rails, and traffic signals.

Specifically, the on-vehicle sensors 20 include a radar sensor 21, an ultrasonic sensor 22, a camera 23, and a navigation system 24.

The radar sensor 21 includes a radar transmission/reception section and a signal processing section (not shown). The radar transmission/reception section radiates a radio wave in the millimeter wave band (hereinafter referred to as “millimeter wave”) to a region around the vehicle, and receives a millimeter wave (i.e., reflection wave) reflected by a three-dimensional object present in the region to which the millimeter wave is radiated. The signal processing section obtains pieces of information representing the distance between the vehicle V and the three-dimensional object, the relative speed between the vehicle V and the three-dimensional object, the position (direction) of the three-dimensional object in relation to the vehicle V, etc. on the basis of the phase difference between the transmitted millimeter wave and the received reflection wave, the level of attenuation of the reflection wave, the time elapsed until the reflection wave is received after the millimeter wave has been transmitted, etc. The signal processing section transmits the obtained pieces of information to the driving assistance ECU 10.

The ultrasonic sensor 22 transmits an ultrasonic wave in the form of pulses to a predetermined region around the vehicle and receives a reflection wave from a three-dimensional object. The ultrasonic sensor 22 obtains pieces of information representing a “reflection point which is a point on the three-dimensional object at which the transmitted ultrasonic wave is reflected,” the “distance between the ultrasonic sensor and the three-dimensional object,” etc. on the basis of the time elapsed until the reflection wave is received after the ultrasonic wave has been transmitted. The ultrasonic sensor 22 transmits the obtained pieces of information to the driving assistance ECU 10.

The camera 23 includes an image capturing device and an image analyzing device. The image capturing device is, for example, a digital camera including an image sensor such as a CCD (charge coupled device) or a CIS (CMOS image sensor). The image capturing device is disposed on an upper portion of a front windshield glass. The image capturing device obtains image data by capturing an image of a scene ahead of the vehicle at a predetermined frame rate and outputs the image data to the image analyzing device. The image analyzing device analyzes the obtained image data, obtains, from the image, pieces of information regarding objects located ahead of the vehicle V, and transmits the obtained pieces of information to the driving assistance ECU 10. For example, the image analyzing device recognizes the lighting color of a traffic light located ahead of the vehicle V in the traveling direction. Also, the image analyzing device recognizes white lines (division line, stop line), etc. on a road and transmits pieces of information representing the recognition results to the driving assistance ECU 10.

The navigation system 24 receives GPS signals from a plurality of artificial satellites and detects the present position (latitude and longitude) of the vehicle V on the basis of the received GPS signals. Also, the navigation system 24 stores map data representing a map. The map data includes pieces of road information representing roads and pieces of traffic light position information representing the installation positions of traffic lights. The navigation system 24 transmits a piece of vehicle position information representing the detected present position to the driving assistance ECU 10. Furthermore, the navigation system 24 has a function of calculating the distance between two points (the distance along a road).

The on-vehicle sensors 20 further include sensors for obtaining pieces of information regarding the travel state (speed, acceleration, operation states of operating elements, etc.) of the vehicle V.

Specifically, the on-vehicle sensors 20 include a speed sensor 25, an acceleration sensor 26, an accelerator pedal sensor 27, a brake pedal sensor 28, a shift lever sensor 29, and a steering sensor 2a.

The speed sensor 25 includes a wheel speed sensor which generates one pulse signal (wheel pulse signal) every time each wheel of the own vehicle rotates a predetermined angle. The speed sensor 25 measures the number of pulses per unit time of the wheel pulse signal transmitted from the wheel speed sensor. The speed sensor 25 calculates the rotational speed (wheel speed) of each wheel on the basis of the measured number of pulses, and calculates the speed vs (actual speed) of the own vehicle on the basis of the wheel speed of each wheel. The speed sensor 25 transmits data representing the speed vs to the driving assistance ECU 10.

The acceleration sensor 26 detects acceleration Ga acting on the vehicle V (for example, acceleration acting in the vehicle width direction of the vehicle V when the vehicle V is traveling along a curved road, acceleration acting in the front-rear direction of the vehicle V when the vehicle V is traveling along a straight road, etc.). The acceleration sensor 26 transmits data representing the acceleration Ga to the driving assistance ECU 10.

The accelerator pedal sensor 27 detects the amount of depression (AD) of an accelerator pedal (not shown) of the vehicle V. The accelerator pedal sensor 27 transmits data representing the amount of depression AD of the accelerator pedal to the driving assistance ECU 10.

A brake pedal sensor 28 detects the amount of depression (BD) of a brake pedal (not shown) of the vehicle V. The brake pedal sensor 28 transmits data representing the amount of depression BD of the brake pedal to the driving assistance ECU 10.

The shift lever sensor 29 detects the position of a shift lever (not shown) of the vehicle V (shift lever position SP). The shift lever sensor 29 transmits data representing the shift lever position SP to the driving assistance ECU 10.

The steering sensor 2a detects the steering angle ϕ of the steering wheel. The steering sensor 2a transmits data representing the detected steering angle ϕ to the driving assistance ECU 10.

Furthermore, the on-vehicle sensors 20 includes various switches provided in the vehicle V (for example, a switch for detecting the operation state of an operation lever of a direction indicator).

The drive apparatus 30 generates drive power and applies the drive power to drive wheels among all wheels (a front left wheel, a front right wheel, a rear left wheel, and a rear right wheel). The drive apparatus 30 includes an engine ECU 31, an engine actuator 32, an internal combustion engine 33, a transmission 34, an unillustrated drive power transmission mechanism for transmitting the drive power to the wheels, etc. The engine ECU 31 is connected to the engine actuator 32. The engine actuator 32 includes a throttle valve actuator for changing the opening degree of a throttle valve of the internal combustion engine 33. The engine ECU 31 obtains the accelerator pedal depression amount AD from the driving assistance ECU 10. Notably, the driving assistance ECU 10 can transmit the depression amount AD obtained from the accelerator pedal sensor 27 to the engine ECU 31 after appropriately correcting the depression amount AD. The engine ECU 31 drives the engine actuator 32 in accordance with the depression amount AD obtained from the driving assistance ECU 10. In this manner, the torque generated by the internal combustion engine 33 is controlled. The torque generated by the internal combustion engine 33 is transmitted to the drive wheels via the transmission 34 and the drive power transmission mechanism (for example, a drive shaft).

Notably, in the case where the vehicle V to which the driving assistance apparatus 1 is applied is a hybrid vehicle (HEV), the engine ECU 31 can control the vehicle drive power generated by either or both of “an internal combustion engine and an electric motor,” which serve as vehicle drive sources. Also, in the case where the vehicle V to which the driving assistance apparatus 1 is applied is a battery electric vehicle (BEV), instead of the engine ECU 31, a motor ECU may be used so as to control the vehicle drive power generated by “an electric motor,” which serves as a vehicle drive source.

The braking apparatus 40 applies braking forces to the wheels. The braking apparatus 40 includes a brake ECU 41, a hydraulic circuit 42, and brake calipers 43. The hydraulic circuit 42 includes, for example, a reservoir, an oil pump, various valve devices, and an oil pressure sensor, which are not illustrated. Each brake caliper 43 is a hydraulic actuator having a cylinder and a piston. When oil is supplied to the cylinder, the piston is pushed out from the cylinder. A brake pad is provided at the distal end of the piston, and this brake pad is pressed against a brake disc. The brake ECU 41 obtains the brake pedal depression amount BD from the driving assistance ECU 10. Notably, the driving assistance ECU 10 can transmit the depression amount BD obtained from the brake pedal sensor 28 to the brake ECU 41 after appropriately correcting the depression amount BD. The brake ECU 41 transmits an oil pressure control instruction to the hydraulic circuit 42 in accordance with the depression amount BD obtained from the driving assistance ECU 10. The hydraulic circuit 42 adjusts the oil pressure within the cylinder of the brake caliper 43 in accordance with the oil pressure control instruction obtained from the brake ECU 41. In this manner, the braking force applied to the corresponding wheel (brake disc) by the brake caliper 43 is controlled.

The shift change apparatus 50 changes the shift position of the transmission 34. The shift change apparatus 50 includes an SBW (shift-by-wire) ECU 51, an SBW actuator 52, a shift change mechanism 53, etc. The SBW ECU 51 is connected to the SBW actuator 52. The SBW ECU 51 obtains the shift lever position SP from the driving assistance ECU 10. The driving assistance ECU 10 can transmit the shift lever position SP to the SBW ECU 51 after appropriately correcting the shift lever position SP obtained from the shift lever sensor 29. The SBW ECU 51 transmits a shift change instruction to the SBW actuator 52 in accordance with the shift lever position SP obtained from the driving assistance ECU 10. The SBW actuator 52 controls the shift change mechanism 53 in accordance with the shift change instruction obtained from the SBW ECU 51. In this manner, the shift position of the transmission 34 is changed.

The steering apparatus 60 controls the steering angle of the steerable wheels (the front left wheel and the front right wheel). The steering apparatus 60 includes an electric power steering ECU (hereinafter referred to as the “EPS ECU”) 61, an assist motor (M) 62, and a steering mechanism 63. The EPS ECU 61 is connected to the assist motor 62 (to a drive circuit for the assist motor 62). The assist motor 62 is built in the steering mechanism 63. The steering mechanism 63 is a mechanism for steering the steerable wheels. The steering mechanism 63 includes a steering wheel SW, a steering shaft US, an unillustrated steering gear mechanism, etc. The EPS ECU 61 detects steering torque input to the steering wheel SW by the driver by using a steering torque sensor (not shown) provided on the steering shaft US and drives the assist motor 62 on the basis of the detected steering torque. The EPS ECU 61 can apply steering torque (steering assist torque) to the steering mechanism 63 through drive of the assist motor 62, thereby assisting the driver’s steering operation.

In addition, the EPS ECU 61 obtains the steering angle ϕ from the driving assistance ECU 10. Notably, the driving assistance ECU 10 can transmit the steering angle ϕ obtained from the steering sensor 2a to the EPS ECU 61 after appropriately correcting the steering angle ϕ. The EPS ECU 61 can transmit a steering instruction to the EPS ECU 61 in accordance with the steering angle ϕ obtained from the driving assistance ECU 10. Upon receipt of the steering instruction from the driving assistance ECU 10, the EPS ECU 61 drives the assist motor 62 on the basis of the steering instruction. The steering torque generated by the assist motor 62 in this case differs from the above-described steering assist torque applied for assisting the driver’s steering operation and is torque which is applied to the steering mechanism 63 in accordance with an steering instruction from the EPS ECU 61 without requiring steering operation by the driver. In this manner, the steering angle of the steerable wheels of the vehicle V is controlled.

### Operation

Next, cruise control executed by the driving assistance apparatus 1 will be described. The cruise control includes constant speed travel control and follow-up control.

The driver can specify whether to execute the cruise control by operating an unillustrated switch. When the driving assistance ECU 10 receives from that switch a cruise control start signal representing that the cruise control is to be started, the driving assistance ECU 10 starts the cruise control (ACC). When the driving assistance ECU 10 starts the cruise control, the driving assistance ECU 10 performs constant speed travel control or follow-up control, which are described below.

### Constant Speed Travel Control

The driving assistance ECU 10 determines, on the basis of the pieces of information obtained from the on-vehicle sensors 20, whether or not there exists a vehicle (preceding vehicle) traveling immediately forward of the own vehicle (within a region extending from the own vehicle to a point located a predetermined distance from the own vehicle). In the case where a preceding vehicle is present, the driving assistance ECU 10 detects the speed v0 of the preceding vehicle. In the case where the detected speed v0 is higher than a predetermined speed vd, the driving assistance ECU 10 controls the drive apparatus 30, the braking apparatus 40, the shift change apparatus 50 (hereinafter referred to as the “drive apparatus, etc.”) such that the speed vs of the own vehicle coincides with the predetermined speed vd (for example, a speed at which the fuel consumption rate of the own vehicle becomes the minimum). Notably, in the case where no preceding vehicle is present (or a preceding vehicle is so remote that the preceding vehicle cannot be detected), the driving assistance ECU 10 assumes that “the speed v0 is higher than the predetermined speed vd.”

### Follow-Up Control

Meanwhile, in the case where the detected speed v0 is equal to or lower than the predetermined speed vd, the driving assistance ECU 10 chooses (employs) that preceding vehicle as a vehicle to follow. Subsequently, the driving assistance ECU 10 detects (actually measures) the intervehicle distance L between the vehicle to follow and the own vehicle on the basis of the pieces of information obtained from the on-vehicle sensors 20. Furthermore, the driving assistance ECU 10 computes the speed and acceleration of the vehicle to follow on the basis of the speed vs of the own vehicle, changes in the intervehicle distance L, etc. Furthermore, the driving assistance ECU 10 computes a target distance Ld for the intervehicle distance L on the basis of the speed of the own vehicle, the speed of the vehicle to follow, etc.

In the case where the speed v0 of the vehicle to follow relative to the speed vs of the own vehicle (relative speed vr = v0 - vs) is larger than “0,” the intervehicle distance L increases. In a state in which the intervehicle distance L has become longer than the target distance Ld, the driving assistance ECU 10 sets a target acceleration of the own vehicle such that the speed vs of the own vehicle becomes higher than the speed v0 of the vehicle to follow. Subsequently, the driving assistance ECU 10 controls the drive apparatus, etc. such that the acceleration of the own vehicle coincides with the target acceleration (hereinafter referred to as “acceleration control”). As a result, the intervehicle distance L having become longer than the target distance Ld starts to decrease to the target distance Ld. When the intervehicle distance L coincides with the target distance Ld, the driving assistance ECU 10 sets the target acceleration of the own vehicle to “0.” Namely, the driving assistance ECU 10 controls the drive apparatus, etc. such that the own vehicle travels at the same speed as the vehicle to follow.

Meanwhile, in the case where the relative speed vr is smaller than “0,” the intervehicle distance L decreases. In a state in which the intervehicle distance L has become shorter than the target distance Ld, the driving assistance ECU 10 sets the target acceleration of the own vehicle such that the speed vs of the own vehicle becomes lower than the speed v0 of the vehicle to follow. Subsequently, the driving assistance ECU 10 controls the drive apparatus, etc. such that the acceleration of the own vehicle coincides with the target acceleration (hereinafter referred to as “deceleration control”). As a result, the intervehicle distance L having become shorter than the target distance Ld starts to increase to the target distance Ld. When the intervehicle distance L coincides with the target distance Ld, the driving assistance ECU 10 sets the target acceleration of the own vehicle to “0.” Notably, the target distance Ld correlates to the speed of the own vehicle and the speed of the vehicle to follow. A database (table) representing the relation between these speeds and the target distance Ld or parameters which define an arithmetic expression for determining the target distance Ld are stored in the ROM 10b.

In a situation where the own vehicle is following the preceding vehicle, the driving assistance ECU 10 performs overtaking control, which will be described next, in the case where the speed vs of the own vehicle is equal to or lower than a threshold speed vth (= vd - Δv) lower than the predetermined speed vd (in the case where a vehicle V0, which is the vehicle to follow, is traveling at an extremely low speed).

### Overtaking Control

In the case where the own vehicle can follow an adjacent vehicle which is traveling faster than the own vehicle in an adjacent lane, the driving assistance ECU 10 changes the vehicle to follow from the vehicle V0 to the adjacent vehicle. Subsequently, the driving assistance ECU 10 causes the own vehicle to enter the adjacent lane (perform a lane change) and to follow the adjacent vehicle, thereby overtaking the the vehicle V0, which was formerly chosen as a vehicle to follow. Subsequently, the driving assistance ECU 10 causes the own vehicle to enter (return to) the lane in which the own vehicle formerly travelled.

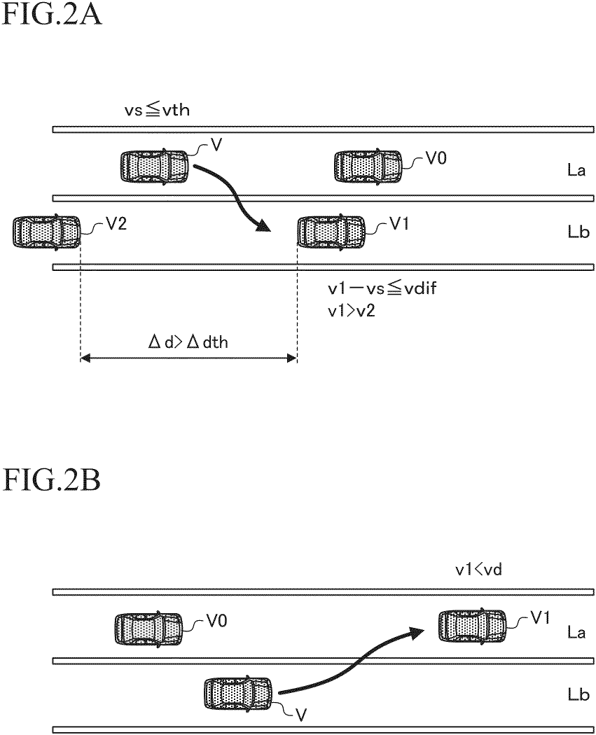

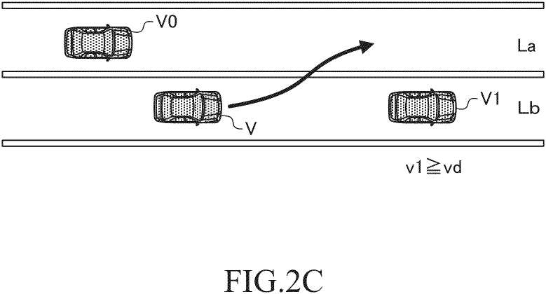

Specifically, the driving assistance ECU 10 searches an adjacent vehicle traveling faster than the own vehicle on the basis of the pieces of information obtained from the on-vehicle sensors 20 and chooses that adjacent vehicle as a candidate of a new vehicle to follow. Namely, in a situation where, as shown in FIG. 2A, the own vehicle is traveling in a lane La while following the vehicle V0, the driving assistance ECU 10 detects the speeds of vehicles which are traveling in a lane Lb adjacent to the lane La and approach the own vehicle from the rear side. The driving assistance ECU 10 then chooses, as a candidate of a new vehicle to follow, a vehicle V1 whose speed difference in relation to the own vehicle is equal to or less than a predetermined threshold difference vdif. Namely, since it is difficult to follow a vehicle which travels at an extremely high speed, the driving assistance ECU 10 excludes such a vehicle from candidates. Notably, in the case where there exist a plurality of vehicles whose speed differences in relation to the own vehicle are equal to or less than the predetermined threshold difference vdif, the driving assistance ECU 10 chooses, as a candidate, a vehicle V1 at the front among those vehicles. However, in this case, the driving assistance ECU 10 may choose, as a candidate, a vehicle which is one of the plurality of vehicles and is other than the vehicle at the front (for example, a vehicle at the end).

In the case where the intervehicle distance Δd between the vehicle V1 (a candidate of a new vehicle to follow chosen as described above) and a vehicle V2 traveling immediately behind the vehicle V1 is relatively small or the case where the vehicle V2 is traveling faster than the vehicle V1, the own vehicle cannot safely enter a space between the vehicle V1 and the vehicle V2 (namely, the own vehicle cannot change its travel lane from the lane La to the lane Lb) in some cases. In view of this, the driving assistance ECU 10 determines whether or not a condition X described below is satisfied. Condition X: The intervehicle distance Δd between the vehicle V1 and the vehicle V2 is longer than a predetermined threshold intervehicle distance Δdth and the vehicle V1 is traveling faster than the vehicle V2.

In the case where the condition X is satisfied, the driving assistance ECU 10 chooses that vehicle V1 as a new vehicle to follow. Meanwhile, in the case where the condition X is not satisfied, the driving assistance ECU 10 does not choose that vehicle V1 as a new vehicle to follow and causes the own vehicle to follow the vehicle V0.

When the driving assistance ECU 10 chooses the vehicle V1 as a new vehicle to follow, the driving assistance ECU 10 controls the drive apparatus, etc. and the steering apparatus 60 such that the own vehicle follows the vehicle V1. Namely, the driving assistance ECU 10 activates the direction indicator, thereby notifying drivers of vehicles around the own vehicle of a lane change. Subsequently, the driving assistance ECU 10 adjusts the steering angle by controlling the steering apparatus 60, while accelerating the own vehicle by controlling the drive apparatus 30 and the shift change apparatus 50, thereby causing the own vehicle to move into a region immediately behind the vehicle V1 (a region between the vehicle V1 and the vehicle V2).

In the above-described manner, the own vehicle can move to a position located obliquely forward of the vehicle V0, which was formally chosen as an vehicle to follow (see FIGS. 2B and 2C). Subsequently, when the speed v1 of the vehicle V1 is equal to or lower than the predetermined speed vd, the driving assistance ECU 10 continuously causes the own vehicle to follow the vehicle V1. Namely, the driving assistance ECU 10 controls the drive apparatus, etc. such that the own vehicle follows the vehicle V1. In the case where the vehicle V1 moves from the lane Lb into the lane La, the driving assistance ECU 10 causes the own vehicle to move from the lane Lb into the lane La to follow the vehicle V1. Notably, in the case where a region into which the own vehicle can move is not present behind the vehicle V1 at a point in time immediately after the vehicle V1 had moved into the lane La, the driving assistance ECU 10 performs constant speed travel control, thereby causing the own vehicle to travel at a constant speed in the lane Lb. At a point in time when presence of a region into which the own vehicle can move is detected in the lane La, the driving assistance ECU 10 causes the own vehicle to move into that region. In this manner, overtaking of the vehicle V0 is completed.

Meanwhile, in the case where the speed v1 of the vehicle V1 (the speed vs of the own vehicle) exceeds the predetermined speed vd after the own vehicle having moved forward in the lane Lb so that the own vehicle is located obliquely forward of the vehicle V0, the driving assistance ECU 10 causes the own vehicle to travel at a constant speed, instead of causing the own vehicle to follow the vehicle V1. Namely, the driving assistance ECU 10 controls the drive apparatus, etc. such that the speed vs of the own vehicle coincides with the predetermined speed vd. Subsequently, upon detection of presence of a region in the lane La into which the own vehicle can move, the driving assistance ECU 10 causes the own vehicle to move into that region. In this manner, overtaking of the vehicle V0 is completed.

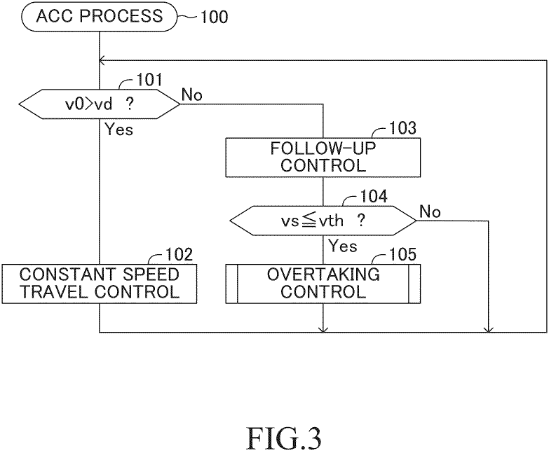

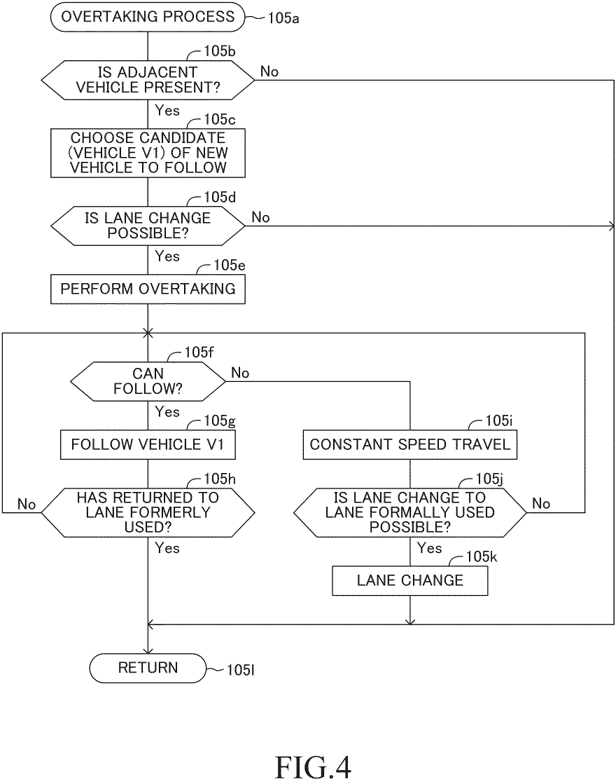

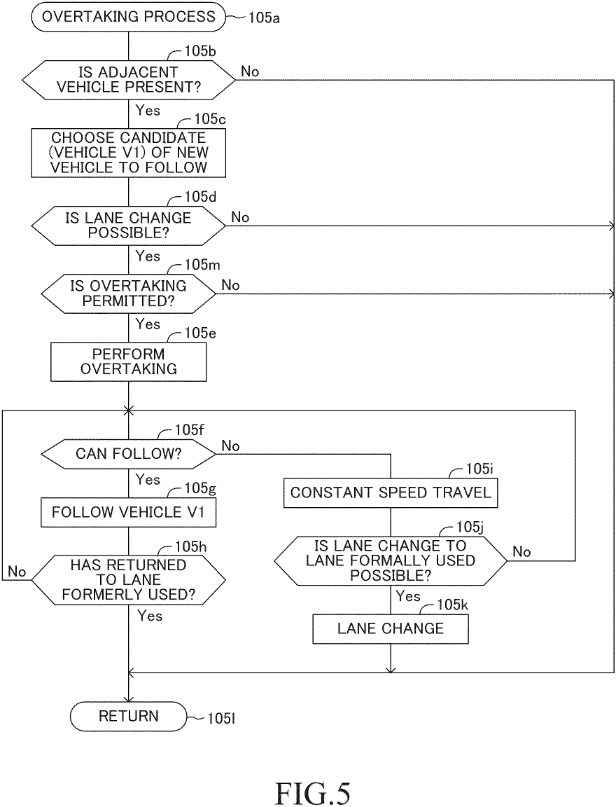

Next, operation of the CPU 10a of the driving assistance ECU 10 (hereinafter referred to simply as the “CPU”) (an ACC program which realizes the above-described cruise control (ACC)) will be described specifically with reference to FIGS. 3 and 4. The CPU starts execution of the ACC program upon receipt, from the above-described switch, of a cruise control start signal representing that the cruise control is to be started.

### ACC Program

The CPU starts an ACC process from step 100 and proceeds to step 101.

When the CPU proceeds to step 101, the CPU detects the speed v0 of the vehicle V0 traveling immediately forward of the own vehicle and determines whether or not the speed v0 is higher than the predetermined speed vd. In the case where the speed v0 is higher than the predetermined speed vd (101: Yes), the CPU proceeds to step 102. Meanwhile, in the case where the speed v0 is equal to or lower than the predetermined speed vd (101: No), the CPU proceeds to step 103.

When the CPU proceeds to step 102, the CPU performs the constant speed travel control. Namely, the CPU controls the drive apparatus, etc. such that the speed vs of the own vehicle coincides with the predetermined speed vd. Subsequently, the CPU returns to step 101.

When the CPU proceeds to step 103, the CPU performs the follow-up control. Namely, the CPU controls the drive apparatus, etc. such that the intervehicle distance L coincides with the target distance Ld. Subsequently, the CPU proceeds to step 104.

When the CPU proceeds to step 104, the CPU determines whether or not the speed vs of the own vehicle is equal to or lower than the threshold speed vth (whether or not the vehicle V0 is traveling at an extremely low speed). In the case where the speed vs is equal to or lower than the threshold speed vth (104: Yes), the CPU proceeds to step 105. Meanwhile, in the case where the speed vs is higher than the threshold speed vth (104: No), the CPU returns to step 101.

When the CPU proceeds to step 105, the CPU executes an overtaking program shown in FIG. 4. The CPU starts an overtaking process from step 105a and proceeds to step 105b.

When the CPU proceeds to step 105b, the CPU determines whether or not an adjacent vehicle (a vehicle traveling in the lane Lb located adjacent to the lane La in which the own vehicle is traveling) is present. In the case where an adjacent vehicle is present (105b: Yes), the CPU proceeds to step 105c. Meanwhile, in the case where no adjacent vehicle is present (105b: No), the CPU proceeds to step 105l and returns to the ACC program.

When the CPU proceeds to step 105c, the CPU chooses the vehicle V1 as a candidate of a new vehicle to follow. Namely, the CPU chooses, as a candidate of a new vehicle to follow, the vehicle V1 whose speed difference in relation to the own vehicle is equal to or smaller than the threshold difference vdif. Subsequently, the CPU proceeds to step 105d.

When the CPU proceeds to step 105d, the CPU determines whether or not a lane change from the lane La to the lane Lb is possible. Namely, the CPU determines whether or not the above-described condition X is satisfied. In the case where the lane change is possible (the case where the condition X is satisfied (105d: Yes)), the CPU proceeds to step 105e. Meanwhile, in the case where the lane change is impossible (the condition X is not satisfied (105d: No)), the CPU proceeds to step 105l.

When the CPU proceeds to step 105e, the CPU chooses the vehicle V1 as a new vehicle to follow and performs control for overtaking the vehicle V0. Namely, the CPU causes the own vehicle to move into the lane Lb, and move forward, while following the vehicle V1, such that the own vehicle is located obliquely forward of the vehicle V0. Subsequently, the CPU proceeds to step 105f.

When the CPU proceeds to step 105f, the CPU determines whether or not it is possible to continuously cause the own vehicle to follow the vehicle V1. Namely, the CPU determines whether or not the speed v1 of the vehicle V1 is equal to or lower than the predetermined speed vd. In the case where it is possible to cause the own vehicle to follow the vehicle V1 (v1 ≤ vd (105f: Yes)), the CPU proceeds to step 105g. Meanwhile, in the case where it is impossible to cause the own vehicle to follow the vehicle V1 (v1 > vd (105f: No)), the CPU proceeds to step 105i.

When the CPU proceeds to step 105g, the CPU causes the own vehicle to follow the vehicle V1. Namely, the CPU controls the drive apparatus, etc. such that the intervehicle distance L between the own vehicle and the vehicle V1 coincides with the target distance Ld. Furthermore, when the CPU detects that the vehicle V1 has changed its travel lane from the lane Lb to the lane La, the CPU determines whether or not a region into which the own vehicle can be moved is present in the lane La. In the case where such a region is present, the CPU causes the own vehicle to move into such a region by controlling the drive apparatus, etc. and the steering apparatus 60. Subsequently, the CPU proceeds to step 105h.

When the CPU proceeds to step 105h, the CPU determines whether or not the own vehicle has returned to the lane La, in which the own vehicle formerly traveled. In the case where the own vehicle has returned to the lane La (105h: Yes), the CPU proceeds to step 105l so as to end the overtaking process and return to the ACC process, which is the main routine. Meanwhile, in the case where the own vehicle is traveling in the lane Lb (105h: No), the CPU returns to step 105f.

When the CPU proceeds to step 105i, the CPU causes the own vehicle to travel at a constant speed. Namely, the CPU controls the drive apparatus, etc. such that the speed vs of the own vehicle coincides with the predetermined speed vd. Subsequently, the CPU proceeds to step 105j.

When the CPU proceeds to step 105j, the CPU determines whether or not a region into which the own vehicle can be moved is present in the lane La. In the case where such a region is present, the CPU proceeds to step 105k. Meanwhile, in the case where such a region is not present (cannot be detected), the CPU returns to step 105f.

When the CPU proceeds to step 105k, the CPU causes the own vehicle to move into the above-described region by controlling the drive apparatus, etc. and the steering apparatus 60. Subsequently, the CPU proceeds to step 105l.

Notably, when the CPU receives a cruise control end signal (signal representing that the ACC control is to be ended (stopped)) from the switch apparatus in the middle of the ACC process, the CPU ends the ACC process after elapse of a predetermined time from that point in time.

### Effects

In the above-described driving assistance apparatus 1, in the case where the vehicle V0 is traveling at an extremely low speed in a state in which the own vehicle follows the vehicle V0, the driving assistance ECU 10 can change the vehicle to follow from the vehicle V0 to the vehicle V1 traveling in the adjacent lane. Thus, the own vehicle can overtake the vehicle V0 while following the vehicle V1. At that time, since the own vehicle follows the vehicle V1 (travels immediately behind the vehicle V1), the air resistance acting on the own vehicle at the time of overtaking is lower as compared with the case where the own vehicle travels solely. Therefore, fuel consumption can be reduced. Also, as a result of overtaking of the vehicle V0, it becomes possible for the own vehicle to travel faster than the vehicle V0 (travel at a speed closer to the predetermined speed vd). Thus, it is possible to reduce delay in time of arrival at a destination, while reducing fuel consumption.

The present invention is not limited to the above-described embodiment, and, as will be described below, various modifications can be employed without departing from the scope of the present invention.

### <Modification 1>

For example, the driving assistance ECU 10 may be programed to obtain a driver’s approval before starting the overtaking process (step 105e in FIG. 3) (see FIG. 4). Namely, in the case where the own vehicle can overtake the vehicle V0, while following the vehicle V1 (105d:Yes), the CPU proceeds to step 105m. In step 105m, the CPU provides a sound or image to the driver, thereby requesting the driver to permit the CPU to perform the control for overtaking the vehicle V0. In the case where the driver transmits a permission signal to the CPU by operating an unillustrated switch apparatus, the CPU proceeds to step 105e and starts the overtaking process. Meanwhile, in the case where the driver transmits a prohibition signal to the CPU by operating the switch apparatus or the case where the driver does not transmit the permission signal or the prohibition signal within a predetermined period of time, the CPU proceeds to step 105l.

### <Modification 2>

In the above-described embodiment, the driving assistance ECU 10 performs the overtaking control in the case where the speed vs of the own vehicle is equal to or lower than the threshold speed vth (= vd - Δv) lower than the predetermined speed vd in a state in which the own vehicle follows the vehicle V0. However, alternatively, the driving assistance ECU 10 may perform the overtaking control in the case where the speed v0 of the vehicle V0 is equal to or lower than the threshold speed vth (= vd - Δv) lower than the predetermined speed vd in a state in which the own vehicle follows the vehicle V0.

### <Modification 3>

In the above-described example, when the condition X is satisfied, the driving assistance ECU 10 determines that it is possible to change the vehicle to follow from the vehicle V0 to the vehicle V1 (possible to follow the vehicle V1). Alternatively, the driving assistance ECU 10 may determine that the own vehicle can follow the vehicle V1 in the following case. Specifically, on the basis of the distance D2 between the own vehicle and the vehicle V2 in the traveling direction, the speed v0 of the own vehicle, and the speed v2 of the vehicle V2, the driving assistance ECU 10 computes (predicts) a time t2 which the vehicle V2 needs to catch up with the own vehicle. In the case where the time t2 is longer than a threshold time T (a time obtained by adding a predetermined margin to a time which the own vehicle needs to perform a lane change), the driving assistance ECU 10 determines that the vehicle to follow can be changed to the vehicle V1. Notably, in the case where the vehicle V2 is not detected (the vehicle V2 is not present in a detectable range), the driving assistance ECU 10 determines that the vehicle to follow can be changed to the vehicle V1.

The vehicle V may be an autonomous vehicle.

1. A driving assistance apparatus comprising:
an on-vehicle sensor which obtains a piece of information regarding the position of an own vehicle, a piece of information regarding objects located around the own vehicle and a piece of information regarding operation of an operation section of the own vehicle and which outputs the obtained pieces of information; and
a control apparatus which detects presence of a preceding vehicle which is traveling immediately forward of the own vehicle, on the basis of the pieces of information obtained from the on-vehicle sensor, chooses the preceding vehicle as a vehicle to follow, and controls at least one of a drive apparatus, a braking apparatus, and a steering apparatus of the own vehicle such that the own vehicle follows the vehicle to follow,
wherein the control apparatus is configured such that, when the own vehicle follows a first vehicle chosen as the vehicle to follow and speed of the own vehicle or speed of the first vehicle is equal to or lower than a predetermined threshold speed, upon determination, on the basis of the pieces of information obtained from the on-vehicle sensor, that the own vehicle can follow a second vehicle which is traveling faster than the own vehicle in a second lane located adjacent to a first lane in which the own vehicle is traveling, the control apparatus changes the vehicle to follow from the first vehicle to the second vehicle.

2. A driving assistance apparatus according to claim 1, wherein the control apparatus is configured to change the vehicle to follow from the first vehicle to the second vehicle in the case where a difference in speed between the own vehicle and the second vehicle in a state in which the own vehicle is traveling in the first lane is equal to or smaller than a predetermined threshold difference.

3. A driving assistance apparatus according to claim 1, wherein the control apparatus is configured such that, in the case where, after the own vehicle has overtaken the first vehicle while following the second vehicle, speed of the second vehicle traveling in the second lane exceeds the threshold speed and a region in which the own vehicle can travel is present in the first lane, the control apparatus controls the drive apparatus, the braking apparatus, and the steering apparatus such that the own vehicle moves from the second lane to the first lane.

4. A driving assistance apparatus according to claim 1, wherein the control apparatus is configured such that, when the control apparatus changes the vehicle to follow from the first vehicle to the second vehicle, the control apparatus detects not only a traveling state of the second vehicle but also a traveling state of a third vehicle traveling behind the second vehicle on the basis of the pieces of information obtained from the on-vehicle sensor, and determines whether or not the own vehicle can follow the second vehicle on the basis of the results of the detection.

5. A driving assistance method comprising:
an information obtaining step of obtaining a piece of information regarding the position of an own vehicle, a piece of information regarding objects located around the own vehicle and a piece of information regarding operation of an operation section of the own vehicle and outputting the obtained pieces of information; and
a control step of detecting presence of a preceding vehicle which is traveling immediately forward of the own vehicle, on the basis of the pieces of information obtained from the on-vehicle sensor, choosing the preceding vehicle as a vehicle to follow, and controlling at least one of a drive apparatus, a braking apparatus, and a steering apparatus of the own vehicle such that the own vehicle follows the vehicle to follow,
wherein the control step comprises a step of changing the vehicle to follow, wherein, when the own vehicle follows a first vehicle chosen as the vehicle to follow and speed of the own vehicle or speed of the first vehicle is equal to or lower than a predetermined threshold speed, upon determination, on the basis of the pieces of information obtained from the on-vehicle sensor, that the own vehicle can follow a second vehicle which is traveling faster than the own vehicle in a second lane located adjacent to a first lane in which the own vehicle is traveling, the vehicle to follow is changed from the first vehicle to the second vehicle in the step of changing the vehicle to follow.

6. A driving assistance program to be applied to a computer provided in a vehicle, the program comprising:
an information obtaining step of obtaining a piece of information regarding position of an own vehicle, a piece of information regarding objects located around the own vehicle and a piece of information regarding operation of an operation section of the own vehicle and outputting the obtained pieces of information; and
a control step of detecting presence of a preceding vehicle which is traveling immediately forward of the own vehicle, on the basis of the pieces of information obtained from the on-vehicle sensor, choosing the preceding vehicle as a vehicle to follow, and controlling at least one of a drive apparatus, a braking apparatus, and a steering apparatus of the own vehicle such that the own vehicle follows the vehicle to follow,
wherein the control step comprises a step of changing the vehicle to follow, wherein, when the own vehicle follows a first vehicle chosen as the vehicle to follow and speed of the own vehicle or speed of the first vehicle is equal to or lower than a predetermined threshold speed, upon determination, on the basis of the pieces of information obtained from the on-vehicle sensor, that the own vehicle can follow a second vehicle which is traveling faster than the own vehicle in a second lane located adjacent to a first lane in which the own vehicle is traveling, the vehicle to follow is changed from the first vehicle to the second vehicle in the step of changing the vehicle to follow.

7. A driving assistance apparatus according to claim 2, wherein the control apparatus is configured such that, in the case where, after the own vehicle has overtaken the first vehicle while following the second vehicle, speed of the second vehicle traveling in the second lane exceeds the threshold speed and a region in which the own vehicle can travel is present in the first lane, the control apparatus controls the drive apparatus, the braking apparatus, and the steering apparatus such that the own vehicle moves from the second lane to the first lane.
